(19) United States
(12) Patent Application Publication
(10) Pub. No.: US 2026/0371174 A1
(43) Pub. Date: Nov. 19, 2026

(54) METHOD AND DEVICE FOR FEEDING BACK INFORMATION

(71) Applicant: BEIJING XIAOMI MOBILE SOFTWARE CO., LTD., Beijing (CN)

(72) Inventor: Xingyi LUO, Beijing (CN)

(21) Appl. No.: 19/148,265

(22) PCT Filed: Jan. 16, 2023
(86) PCT No.: PCT/CN2023/072436

§ 371 Date: Jul. 15, 2025

(51) Int. Cl. H04W 36/00; H04L 1/1607; H04L 5/00; H04W 36/08

(52) U.S. Cl. CPC H04W 36/0016; H04L 1/1642; H04L 5/0044; H04W 36/08

(57) ABSTRACT

A method for feeding back information, performed by a network device, including: determining a feedback of a terminal on a physical downlink shared channel (PDSCH) previously transmitted by a source cell of the network device, in a case where a cell handover message transmitted by the terminal is received by a target cell of the network device but feedback information from the terminal about the PDSCH has not yet been received.

### CROSS-REFERENCE TO RELATED APPLICATION

The present application is a U.S. National Stage of International Application No. PCT/CN2023/072436, filed on Jan. 16, 2023, the contents of all of which are incorporated herein by reference in their entirety for all purposes.

### BACKGROUND OF THE INVENTION

In related art, a network device maintains a plurality of candidate cells for a terminal and configures an evaluation condition for the terminal. The terminal may determine whether to perform a cell switch according to whether a layer 1 (L1) measurement result satisfies the evaluation condition. In a case of determining to perform the cell switch, the terminal may be accessed to a target cell.

### SUMMARY OF THE INVENTION

The present disclosure relates to the technical field of communication, and in particular to a method and device for feeding back information.

In a first aspect, the embodiments of the present disclosure provide a method for feeding back information. The method is performed by a network device and includes: determining, by the network device, a feedback of a terminal on a physical downlink shared channel (PDSCH) previously transmitted by a source cell of the network device, in a case where a cell handover message transmitted by the terminal is received by a target cell of the network device but feedback information from the terminal about the PDSCH has not yet been received.

In a second aspect, the embodiments of the present disclosure provide a method for feeding back information. The method is performed by a terminal and includes: transmitting a cell handover message to a target cell of a network device, where the cell handover message is configured to indicate that the terminal needs to be switched from a source cell to the target cell; and determining to perform a specific processing flow to feed back feedback information about a physical downlink shared channel (PDSCH) previously transmitted by the source cell of the network device, in a case where the feedback information about the PDSCH previously transmitted by the source cell of the network device has not yet been fed back.

In a third aspect, the embodiments of the present disclosure provide a communication device. The communication device has all or part of the functions of the network device in the method in the first aspect. For example, the communication device may have the functions for implementing all or part of the embodiments of the present disclosure or may have the functions for separately implementing any one embodiment of the present disclosure. The functions may be realized by hardware or corresponding software executed by hardware. The hardware or software includes one or more units or modules corresponding to the functions.

In an implementation, the communication device may include a transceiving module and a processing module. The processing module is configured to support the communication device in implementing corresponding functions in the method. The transceiving module is configured to support communications between the communication device and other devices. The communication device may further include a storage module. The storage module is configured to be coupled with the transceiving module and the processing module, and stores a computer program and data necessary for the communication device.

In an implementation, the communication device includes the processing module, configured for a network device to determine a feedback of a terminal on a PDSCH previously transmitted by a source cell of the network device, in a case where a cell handover message transmitted by the terminal is received by a target cell of the network device but the network device has not yet received feedback information from the terminal about the PDSCH.

In a fourth aspect, the embodiments of the present disclosure provide a communication device. The communication device has all or part of the functions of the terminal in the method in the second aspect. For example, the communication device may have the functions for implementing all or part of the embodiments of the present disclosure or may have the functions for separately implementing any one embodiment of the present disclosure. The functions may be realized by hardware or corresponding software executed by the hardware. The hardware or software includes one or more units or modules corresponding to the functions.

In an implementation, the communication device may include a transceiving module and a processing module. The processing module is configured to support the communication device in implementing corresponding functions in the method. The transceiving module is configured to support communications between the communication device and other devices. The communication device may further include a storage module. The storage module is configured to be coupled with the transceiving module and the processing module, and stores a computer program and data necessary for the communication device.

In an implementation, the communication device includes: the transceiving module, configured to transmit a cell handover message to a target cell of a network device, where the cell handover message is configured to indicate that a terminal needs to be switched from a source cell to the target cell; and the processing module, configured to determine to perform a specific processing flow to feed back feedback information about a PDSCH previously transmitted by the source cell of the network device, in a case where the feedback information about the PDSCH previously transmitted by the source cell of the network device has not yet been fed back.

In a fifth aspect, the embodiments of the present disclosure provide a communication device. The communication device includes one or more processors, where the one or more processors, when collectively calling a computer program in a memory, perform the method in the first aspect.

In a sixth aspect, the embodiments of the present disclosure provide a communication device. The communication device includes one or more processors, where the one or more processors, when collectively calling a computer program in a memory, perform the method in the second aspect.

In a seventh aspect, the embodiments of the present disclosure provide a communication device. The communication device includes one or more processors and a memory, where the memory stores a computer program, and the one or more processors execute the computer program stored in the memory to cause the communication device to perform the method in the first aspect.

In an eighth aspect, the embodiments of the present disclosure provide a communication device. The communication device includes one or more processors and a memory, where the memory stores a computer program, and the one or more processors execute the computer program stored in the memory to cause the communication device to perform the method in the second aspect.

In a ninth aspect, the embodiments of the present disclosure provide a communication device. The communication device includes one or more processors and an interface circuit, where the interface circuit is configured to receive code instructions and transmit the code instructions to the one or more processors, and the one or more processors are collectively configured to run the code instructions to cause the communication device to perform the method in the first aspect.

In a tenth aspect, the embodiments of the present disclosure provide a communication device. The communication device includes one or more processors and an interface circuit, where the interface circuit is configured to receive code instructions and transmit the code instructions to the one or more processors, and the one or more processors are collectively configured to run the code instructions to cause the communication device to perform the method in the second aspect.

In an eleventh aspect, the embodiments of the present disclosure provide an information feedback system. The information feedback system includes the communication device in the third aspect and the communication device in the fourth aspect, or the information feedback system includes the communication device in the fifth aspect and the communication device in the sixth aspect, or the information feedback system includes the communication device in the seventh aspect and the communication device in the eighth aspect, or the information feedback system includes the communication device in the ninth aspect and the communication device in the tenth aspect.

In a twelfth aspect, the embodiments of the present disclosure provide a non-transitory computer-readable storage medium, configured to store instructions used for a network device, where the instructions, when executed, causes the network device to implement the method in the first aspect.

In a thirteenth aspect, the embodiments of the present disclosure provide a non-transitory computer-readable storage medium, configured to store instructions used for a terminal, where the instructions, when executed, causes the terminal to implement the method in the second aspect.

In a fourteenth aspect, the present disclosure further provides a computer program product including a computer program, where the computer program, when running on a computer, causes the computer to perform the method in the first aspect.

In a fifteenth aspect, the present disclosure further provides a computer program product including a computer program, where the computer program, when running on a computer, causes the computer to perform the method in the second aspect.

In a sixteenth aspect, the present disclosure provides a chip system. The chip system includes at least one processor and an interface and is configured to support a network device in realizing functions involved in the first aspect, for example, determining or processing at least one of data or information involved in the method. In a design, the chip system further includes a memory, where the memory is configured to store a computer program and data necessary for the network device. The chip system may be formed by a chip or may include a chip and other discrete devices.

In a seventeen aspect, the present disclosure provides a chip system. The chip system includes at least one processor and an interface and is configured to support a terminal in realizing functions involved in the second aspect, for example, determining or processing at least one of data or information involved in the method. In a design, the chip system further includes a memory, where the memory is configured to store a computer program and data necessary for the terminal. The chip system may be formed by a chip or may include a chip and other discrete devices.

In an eighteenth aspect, the present disclosure provides a computer program, where the computer program, when running on a computer, causes the computer to perform the method in the first aspect.

In a nineteenth aspect, the present disclosure provides a computer program, where the computer program, when running on a computer, causes the computer to perform the method in the second aspect.

### BRIEF DESCRIPTION OF DRAWINGS

In order to more clearly explain the technical solutions in the embodiments of the present disclosure or the background art, drawings used in the embodiments of the present disclosure or the background art are described below.

FIG. 1 is an architecture diagram of a communication system according to an embodiment of the present disclosure.

FIG. 2 is a schematic diagram of L1/L2-based inter-cell mobility according to an embodiment of the present disclosure.

FIG. 3 is a flowchart of a method for feeding back information according to an embodiment of the present disclosure.

FIG. 4 is a flowchart of a method for feeding back information according to another embodiment of the present disclosure.

FIG. 5 is a flowchart of a method for feeding back information according to yet another embodiment of the present disclosure.

FIG. 6 is a flowchart of a method for feeding back information according to yet another embodiment of the present disclosure.

FIG. 7 is a flowchart of a method for feeding back information according to yet another embodiment of the present disclosure.

FIG. 8 is a flowchart of a method for feeding back information according to yet another embodiment of the present disclosure.

FIG. 9 is a flowchart of a method for feeding back information according to yet another embodiment of the present disclosure.

FIG. 10 is a flowchart of a method for feeding back information according to yet another embodiment of the present disclosure.

FIG. 11 is a flowchart of a method for feeding back information according to yet another embodiment of the present disclosure.

FIG. 12 is a schematic diagram of a method for feeding back information according to yet another embodiment of the present disclosure.

FIG. 13 is a schematic diagram of a method for feeding back information according to yet another embodiment of the present disclosure.

FIG. 14 is a structural diagram of a communication device according to an embodiment of the present disclosure.

FIG. 15 is a structural diagram of a communication device according to another embodiment of the present disclosure.

FIG. 16 is a schematic structural diagram of a chip according to an embodiment of the present disclosure.

### DETAILED DESCRIPTION OF THE INVENTION

For a better understanding of a method and device for feeding back information disclosed by the embodiments of the present disclosure, a communication system applicable to the embodiments of the present disclosure is described first.

The embodiments of the present disclosure are described in detail below. Examples of the embodiments are illustrated in the drawings, where identical or similar reference signs indicate identical or similar elements or elements with identical or similar functions. The embodiments described below with reference to the drawings are merely illustrative for explaining the present disclosure and should not be construed as limitations to the present disclosure. In the description of the present disclosure, unless otherwise stated, “/” means “or”, for example, A/B may indicate A or B. In the present disclosure, “and/or” merely describes an association between related objects and indicates three relations. For example, “A and/or B” may indicate a case where only A exists, a case where both A and B exist and a case where only B exits.

In related art, a network device maintains a plurality of candidate cells for a terminal and configures an evaluation condition for the terminal. The terminal may determine whether to perform a cell switch according to whether a layer 1 (L1) measurement result satisfies the evaluation condition. In a case of determining to perform the cell switch, the terminal may be accessed to a target cell.

However, in a case where the terminal determines to perform the cell switch, there may be a case where feedback information about a physical downlink shared channel (PDSCH) transmitted by the network device has not yet been fed back. Assuming that the terminal interrupts transmission of the feedback information to perform the cell switch, the network device may not determine whether the PDSCH is successfully transmitted. This is a problem urgently to be solved.

Referring to FIG. 1, FIG. 1 is a schematic architecture diagram of a communication system according to an embodiment of the present disclosure. The communication system 10 may include, but is not limited to, a network device 101 and a terminal 102. A number and form of devices shown in FIG. 1 are merely for illustration and should not be construed as limitations to the embodiments of the present disclosure. In actual application, the communication system 10 may include two or more network devices 101 and two or more terminals 102. As an example, the communication system 10 in FIG. 1 includes one network device 101 and one terminal 102.

It is to be noted that the technical solutions in the embodiments of the present disclosure may be applied to various communication systems, such as a long term evolution (LTE) system, a 5th generation (5G) mobile communication system, a 5G new radio (NR) system, or other novel mobile communication systems in the future.

The network device 101 in the embodiments of the present disclosure is an entity, used for transmitting or receiving a signal, on a network side. For example, the network device 101 may be an evolved NodeB (eNB), a transmission reception point (TRP), a next generation NodeB (gNB) in an NR system, a base station in other mobile communication systems in the future, an access point in a wireless fidelity (Wi-Fi) system, or the like. The technique and form of the network device 101 in the embodiments of the present disclosure are not limited. The network device 101 provided by the embodiments of the present disclosure may be formed by a central unit (CU) and distributed units (DUs). The CU may also be referred to as a control unit. By adopting the CU-DU structure, the network device 101, such as a protocol layer of the network device 101, may be split, and part of the functions of the protocol layer are configured in the CU to be controlled in a centralized manner, part or all of the remaining functions of the protocol layer are distributed in the DUs, and the DUs are controlled by the CU in a centralized manner.

The terminal 102 in the embodiments of the present disclosure is an entity, used for receiving or transmitting a signal, on a user side, such as a mobile phone. The terminal may also be referred to as a user equipment (UE), a terminal device, a mobile station (MS), a mobile terminal (MT), and the like. The terminal may be a car with a communication function, a smart car, a mobile phone, a wearable device, a Pad, a computer with a wireless transceiving function, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, and the like. The technique and form of the terminal in the embodiments of the present disclosure are not limited.

It may be understood that the communication system described in the embodiments of the present disclosure is used for more clearly expounding the technical solutions in the embodiments of the present disclosure rather than limiting the technical solutions in the embodiments of the present disclosure. Those ordinarily skilled in the art may appreciate that with the evolution of the system architecture and the appearance of new business scenarios, the technical solutions provided by the embodiments of the present disclosure are also applicable for similar technical problems.

In addition, for the sake of a good understanding of the embodiments of the present disclosure, the following statements are made.

First, in the embodiments of the present disclosure, “configured to indicate” may include “directly indicate” and “indirectly indicate”. In case of an expression that a certain information is configured to indicate A, this information may carry A, or this information may directly indicate A or indirectly indicate A, but it does not mean that this information definitely carries A.

A message indicated by the information is referred to as a to-be-indicated message. In a specific implementation process, the to-be-indicated message may be indicated in various ways, for example, but is not limited to, the to-be-indicated message may be indicated directly, such as the to-be-indicated message itself or an index of the to-be-indicated message. Alternatively, the to-be-indicated message may be indirectly indicated by other messages, where the other messages are associated with the to-be-indicated message. Alternatively, only a portion of the to-be-indicated message is indicated, and other portions of the to-be-indicated message are known or agreed in advance. For example, the to-be-indicated message may be indicated through an order of messages agreed in advance (for example, specified by an agreement) so as to reduce indication overhead to some extent.

The to-be-indicated message may be transmitted as a whole or be split into a plurality of sub-messages that are transmitted separately, and at least one of transmission periods or transmission occasions of the sub-messages may be the same or different. The specific transmission manner is not limited by the present disclosure. At least one of the transmission periods or the transmission occasions of the sub-messages may be predefined, for example, according to an agreement.

Second, in the present disclosure, “first,” “second” and various numerical symbols (such as, “#1” and “#2”) are merely for distinguishing, for example, different messages, for the convenience of description and are not intended to limit the scope of the embodiments of the present disclosure.

Third, a plurality of implementations are enumerated to more clearly explain the technical solutions in the embodiments of the present disclosure. Those skilled in the art may appreciate that a plurality of embodiments of the present disclosure may be implemented separately, or may be combined with methods in other embodiments of the present disclosure to be implemented together, or may be implemented together with some methods in other related art separately or after being combined. The embodiments of the present disclosure have no limitation in this aspect.

In discussion of mobility enhancement in Release 18 (Rel-18), it is desired to support L1 measurement result-and L1/L2 signaling-based inter-cell mobility (LTM). In related art, such enhancement mainly aims at the mobility in inter-DU and intra-DU scenarios.

In the inter-DU scenario, a source cell and a target cell for cell switch are respectively connected to different DUs. In the intra-DU scenario, a source cell and a target cell for cell switch are connected to a same DU.

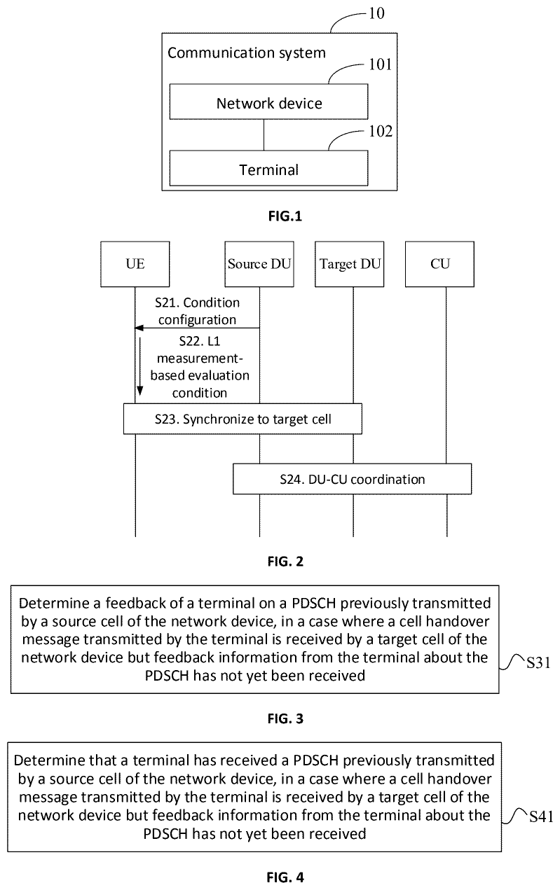

As shown in steps S21 to S24 in FIG. 2, as a possible LTM step, the network device maintains a plurality of candidate cells for UE through pre-configuration and configures an evaluation condition for the UE. The terminal may determine whether to perform a cell switch according to whether a layer 1 (L1) measurement result satisfies the evaluation condition. In a case of determining to perform the cell switch, the terminal may be accessed to a target cell.

However, in a case where the terminal determines to perform the cell switch, there may be a case where hybrid automatic repeat request (HARQ)-acknowledge (ACK) feedback information about a PDSCH transmitted by the network device has not yet been fed back. Assuming that the terminal interrupts transmission of the feedback information to perform the cell switch, the network device may not determine whether the PDSCH is successfully transmitted. This is a problem urgently to be solved.

In view of this, the embodiments of the present disclosure provide a method for feeding back information. A network device determines a feedback of a terminal on a PDSCH previously transmitted by a source cell of the network device, in a case where a cell handover message transmitted by the terminal is received by a target cell of the network device but the network device has not yet received feedback information of HARQ-ACK from the terminal about the PDSCH. Thus, the network device may determine the feedback of the terminal on the PDSCH transmitted by the source cell of the network device before the cell handover message, and the network device may determine whether the PDSCH is successfully transmitted, thereby avoiding data loss or reducing repeated transmission of data.

A method and device for feeding back information provided by the present disclosure are introduced in detail below in conjunction with the drawings.

Referring to FIG. 3, FIG. 3 is a flowchart of a method for feeding back information according to an embodiment of the present disclosure. As shown in FIG. 3, the method is performed by a network device and may include, but is not limited to, step S31.

Step S31 includes determining a feedback of a terminal on a PDSCH previously transmitted by a source cell of the network device, in a case where a cell handover message transmitted by the terminal is received by a target cell of the network device but the network device has not yet received feedback information from the terminal about the PDSCH.

In the embodiments of the present disclosure, the network device determines the feedback of the terminal on the PDSCH previously transmitted by the source cell of the network device, in a case where the cell handover message transmitted by the terminal is received by the target cell of the network device but the network device has not yet received the feedback information from the terminal about the PDSCH.

In some implementations, the network device determining the feedback of the terminal on the PDSCH may include determining that the terminal has received the PDSCH.

For example, the network device may determine by default that the feedback information about the previously transmitted PDSCH is acknowledge (ACK) information/message.

In some other implementations, the network device determining the feedback of the terminal on the PDSCH may include determining that the terminal has not received the PDSCH.

For example, the network device may determine by default that the feedback information about the previously transmitted PDSCH is not acknowledge (NACK) information/message.

For example, in a case where the network device determines by default that the terminal has not received the PDSCH, the network device may retransmit data that is not successfully transmitted, to the terminal through the target cell after the terminal completes the cell switch.

In yet some implementations, the network device determining the feedback of the terminal on the PDSCH may include receiving feedback information transmitted, after the terminal is switched from the source cell to the target cell, to the target cell of the network device by the terminal.

In the embodiments of the present disclosure, the cell handover message may inform the target cell that the terminal needs to be switched from the source cell to the target cell. The source cell and the target cell may be connected to a same DU or may be respectively connected to different DUs. The embodiments of the present disclosure have no limitation in this aspect.

In the embodiments of the present disclosure, the target cell receives the cell handover message transmitted by the terminal. The cell handover message may be new defined dedicated information or a random access initiated by the terminal.

In some embodiments, the network device stops or continues at least one of an uplink data transmission or a downlink data transmission through the source cell, in a case where the cell handover message transmitted by the terminal is received through the target cell.

In the embodiments of the present disclosure, the network device may stop at least one of the uplink data transmission or the downlink data transmission through the source cell, in a case where the cell handover message transmitted by the terminal is received through the target cell.

It may be understood that in a case where the terminal does not support maintaining transmission with the source cell while accessing to the target cell, the network device may stop at least one of the uplink data transmission or the downlink data transmission through the source cell in the case where the cell handover message transmitted by the terminal is received through the target cell.

In an embodiment of the present disclosure, the network device may continue at least one of the uplink data transmission or the downlink data transmission through the source cell, in the case where the cell handover message transmitted by the terminal is received through the target cell.

It may be understood that in a case where the terminal supports maintaining transmission with the source cell while accessing to the target cell, the network device may continue at least one of the uplink data transmission or the downlink data transmission through the source cell in the case where the cell handover message transmitted by the terminal is received through the target cell.

It is to be noted that in a case where the network device continues at least one of the uplink data transmission or the downlink data transmission through the source cell in the case where the cell handover message transmitted by the terminal is received through the target cell, the network device may determine to stop at least one of the uplink data transmission or the downlink data transmission through the source cell in a case of determining that the terminal completes the switch from the source cell to the target cell or may determine to stop at least one of the uplink data transmission or the downlink data transmission through the source cell in a case of determining that the terminal satisfies other conditions. The embodiments of the present disclosure have no limitation in this aspect.

In some embodiments, in a case of the cell handover message transmitted by the terminal being received through the target cell and determining that the terminal completes the switch from the source cell to the target cell, the network device determines to stop at least one of the uplink data transmission or the downlink data transmission through the source cell.

In the embodiments of the present disclosure, the network device determines to stop at least one of the uplink data transmission or the downlink data transmission through the source cell in the case where the cell handover message transmitted by the terminal is received through the target cell and it is determined that the terminal completes the switch from the source cell to the target cell.

It is to be noted that, in a case where the cell handover message transmitted by the terminal is received through the target cell, the network device may maintain at least one of the uplink data transmission or the downlink data transmission with the terminal through the source cell before determining that the terminal completes the switch from the source cell to the target cell.

In some embodiments, the network device transmits second indication information to the terminal through the target cell after the terminal completes the switch from the source cell to the target cell. The second indication information is configured to instruct the terminal to release resources of the source cell.

In the embodiments of the present disclosure, the network device may transmit the second indication information to the terminal through the target cell after the terminal completes the switch from the source cell to the target cell. The second indication information is configured to instruct the terminal to release the resources of the source cell.

Based on this, in a case where the terminal supports maintaining transmission with the source cell while accessing to the target cell, the terminal may determine to stop at least one of the uplink data transmission or the downlink data transmission with the source cell in the case where the second indication information transmitted by the network device is received by the terminal.

It may be understood that in a case where the source cell and the target cell of the network device are connected to a same DU and where the terminal does not support maintaining transmission with the source cell while accessing to the target cell, the source cell may stop at least one of the uplink data transmission or the downlink data transmission with the terminal in a case where the cell handover message transmitted by the terminal is received by the target cell. In a case where the source cell and the target cell of the network device are connected to a same DU and where the terminal supports maintaining transmission with the source cell while accessing to the target cell, the source cell may maintain at least one of the uplink data transmission or the downlink data transmission with the terminal in a case where the cell handover message transmitted by the terminal is received by the target cell, and the source cell may stop at least one of the uplink data transmission or the downlink data transmission with the terminal after the terminal completes the cell switch.

It may be further understood that in a case where the source cell and the target cell of the network device are respectively connected to different DUs and where the terminal does not support maintaining transmission with the source cell while accessing to the target cell, the source cell may stop at least one of the uplink data transmission or the downlink data transmission with the terminal in a case where the cell handover message transmitted by the terminal is received by the target cell. In a case where the source cell and the target cell of the network device are respectively connected to different DUs and where the terminal supports maintaining transmission with the source cell while accessing to the target cell, the source cell may maintain at least one of the uplink data transmission or the downlink data transmission with the terminal in a case where the cell handover message transmitted by the terminal is received by the target cell, and the source cell may stop at least one of the uplink data transmission or the downlink data transmission with the terminal in a case where a handover success message transmitted by the target cell is received by the source cell after the terminal completes the cell switch.

According to the embodiments of the present disclosure, the network device determines the feedback of the terminal on the PDSCH previously transmitted by the source cell of the network device, in a case where the cell handover message transmitted by the terminal is received by the target cell of the network device but the network device has not yet received the feedback information from the terminal about the PDSCH. Thus, the network device may determine the feedback of the terminal on the PDSCH transmitted by the source cell of the network device before the cell handover message, and the network device may determine whether the PDSCH is successfully transmitted, thereby avoiding data loss or reducing repeated transmission of data.

Referring to FIG. 4, FIG. 4 is a flowchart of a method for feeding back information according to another embodiment of the present disclosure. As shown in FIG. 4, the method is performed by a network device and may include, but is not limited to, step S41.

Step S41 includes determining that a terminal has received a PDSCH previously transmitted by a source cell of the network device, in a case where a cell handover message transmitted by the terminal is received by a target cell of the network device but the network device has not yet received feedback information from the terminal about the PDSCH.

In the embodiments of the present disclosure, for a related description of step S41, reference may be made to the related description in other embodiments, which will not be repeated here.

In the embodiments of the present disclosure, the network device may determine that the terminal has received the previously transmitted PDSCH, in a case where the cell handover message transmitted by the terminal is received by the network device but the network device has not yet received the feedback information from the terminal about the PDSCH.

The network device may determine by default that the feedback information from the terminal on the previously transmitted PDSCH is received, and the feedback information is acknowledge (ACK) information/message.

In the embodiments of the present disclosure, the cell handover message may indicate that the terminal needs to be switched from the source cell to the target cell. The source cell and the target cell may be connected to a same DU or may be respectively connected to different DUs. The embodiments of the present disclosure have no limitation in this aspect.

It is to be noted that in the embodiments of the present disclosure, step S41 may be implemented separately or may be implemented together with any of other steps in the embodiments of the present disclosure, for example, together with step S31 in the embodiments of the present disclosure. The embodiments of the present disclosure have no limitation in this aspect.

According to the embodiments of the present disclosure, the network device determines that the terminal has received the PDSCH previously transmitted by the source cell of the network device, in a case where the cell handover message transmitted by the terminal is received by the target cell of the network device but the network device has not yet received the feedback information from the terminal about the PDSCH. Thus, the network device may determine the feedback of the terminal on the PDSCH transmitted by the source cell of the network device before the cell handover message, and the network device may determine whether the PDSCH is successfully transmitted, thereby avoiding data loss or reducing repeated transmission of data.

Referring to FIG. 5, FIG. 5 is a flowchart of a method for feeding back information according to yet another embodiment of the present disclosure. As shown in FIG. 5, the method is performed by a network device and may include, but is not limited to, steps S51 and S52.

Step S51 includes determining that a terminal has not received a PDSCH previously transmitted by a source cell of the network device, in a case where a cell handover message transmitted by the terminal is received by a target cell of the network device but the network device has not yet received feedback information from the terminal about the PDSCH.

In the embodiments of the present disclosure, for a related description of step S51, reference may be made to the related description in other embodiments, which will not be repeated here.

In the embodiments of the present disclosure, the network device may determine that the terminal has not received the previously transmitted PDSCH, in a case where the cell handover message transmitted by the terminal is received by the network device but the network device has not yet received the feedback information from the terminal about the PDSCH.

The network device may determine by default that the feedback information from the terminal about the previously transmitted PDSCH is received, and the feedback information is not acknowledge (NACK) information/message.

Step S52 includes transmitting/retransmitting, by the target cell of the network device, data that is not successfully transmitted, to the terminal after the terminal completes the switch from the source cell to the target cell.

In the embodiments of the present disclosure, the network device may transmit/retransmit the data that is not successfully transmitted, to the terminal through the target cell after the terminal completes the switch from the source cell to the target cell.

In the embodiments of the present disclosure, the cell handover message may indicate that the terminal needs to be switched from the source cell to the target cell. The source cell and the target cell may be connected to a same DU or may be respectively connected to different DUs. The embodiments of the present disclosure have no limitation in this aspect.

It may be understood that in a case where the source cell and the target cell are connected to a same DU, the target cell and the source cell of the network device share a same physical layer, a same Medium Access Control (MAC) layer and a same Radio Link Control (RLC) layer. Thus, the target cell may retransmit the data that is not successfully transmitted, to the terminal.

It may be understood that in a case where the source cell and the target cell are respectively connected to different DUs, physical layers and MAC layers of the target cell and the source cell of the network device are different, the source cell may transmit a sequence number (SN) state message to the target cell, the target cell performs data transmission according to the SN state message, and may retransmit a packet data convergence protocol (PDCP) service data unit (SDU)/protocol data unit (PDU), that is determined by default to be not successfully transmitted by the source cell.

It is to be noted that in the embodiments of the present disclosure, step S51 and step S52 may be implemented separately or may be implemented together with any of other steps in the embodiments of the present disclosure, for example, together with at least one of step S31 or step S41 in the embodiments of the present disclosure. The embodiments of the present disclosure have no limitation in this aspect.

According to the embodiments of the present disclosure, in a case where the cell handover message transmitted by the terminal is received by the target cell of the network device but the feedback information from the terminal about the PDSCH previously transmitted by the source cell of the network device has not yet been received, the network device determines that the terminal has not received the PDSCH; and after the terminal completes the switch from the source cell to the target cell, the target cell of the network device transmits/retransmits the data that is not successfully transmitted, to the terminal. Thus, the network device may determine the feedback of the terminal on the PDSCH transmitted by the source cell of the network device before the cell handover message, and the network device may determine whether the PDSCH is successfully transmitted, thereby avoiding data loss or reducing repeated transmission of data.

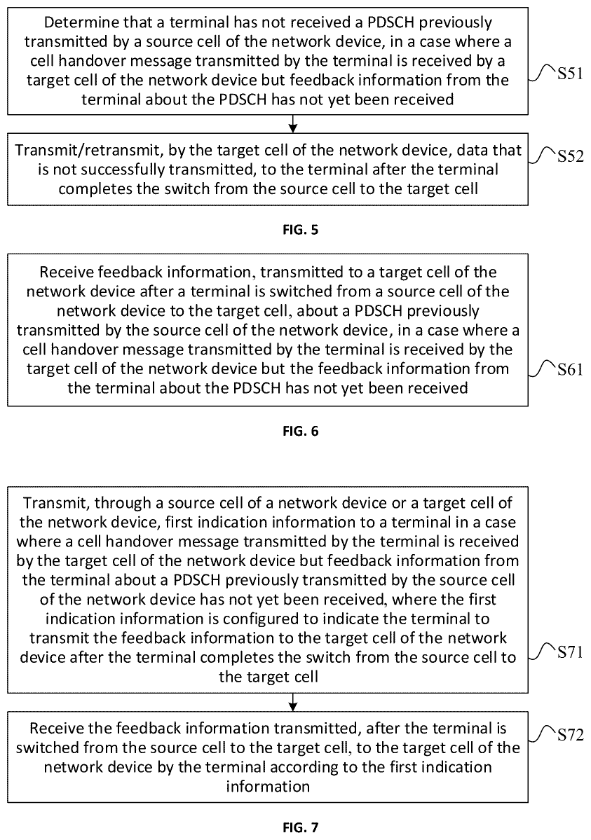

Referring to FIG. 6, FIG. 6 is a flowchart of a method for feeding back information according to yet another embodiment of the present disclosure. As shown in FIG. 6, the method is performed by a network device and may include, but is not limited to, step S61.

Step S61 includes receiving feedback information, transmitted to a target cell of the network device after a terminal is switched from a source cell of the network device to the target cell, about a PDSCH previously transmitted by the source cell of the network device, in a case where a cell handover message transmitted by the terminal is received by the target cell of the network device but the feedback information from the terminal about the PDSCH has not yet been received.

In the embodiments of the present disclosure, for a related description of step S61, reference may be made to the related description in other embodiments, which will not be repeated here.

In the embodiments of the present disclosure, in a case where the cell handover message transmitted by the terminal is received but the feedback information from the terminal about the previously transmitted PDSCH has not yet been received, the network device may receive the feedback information transmitted, after the terminal is switched from the source cell to the target cell, to the target cell of the network device by the terminal.

In the embodiments of the present disclosure, the cell handover message may indicate that the terminal needs to be switched from the source cell to the target cell. The source cell and the target cell may be connected to a same DU or may be respectively connected to different DUs. The embodiments of the present disclosure have no limitation in this aspect.

In some embodiments, receiving, by the network device, the feedback information transmitted, after the terminal is switched from the source cell to the target cell, to the target cell of the network device by the terminal includes: receiving the feedback information transmitted, after the terminal is switched from the source cell to the target cell, to the target cell of the network device by the terminal, where the feedback information includes packet data convergence protocol (PDCP) sequence number (SN) information.

In the embodiments of the present disclosure, the network device receiving the feedback information transmitted, after the terminal is switched from the source cell to the target cell, to the target cell of the network device by the terminal may include receiving the feedback information transmitted, after the terminal is switched from the source cell to the target cell, to the target cell of the network device by the terminal, where the feedback information may include the PDCP SN information.

In some embodiments, the network device receives the feedback information transmitted, in a case where the source cell and the target cell are respectively connected to different DUs, to the target cell of the network device by the terminal, where the feedback information includes the PDCP SN information.

In the embodiments of the present disclosure, in the case where the source cell and the target cell are respectively connected to different DUs, the network device may receive the feedback information transmitted by the terminal to the target cell of the network device, where the feedback information includes the PDCP SN information.

In the embodiments of the present disclosure, the network device may configure, in advance, at least one candidate cell for the terminal, including related configuration information for the candidate cell, such as a DU to which the candidate cell is connected. The terminal may select the target cell from the at least one candidate cell, and the terminal may determine whether the source cell and the target cell are respectively connected to different DUs according to the related configuration information configured by the network device for the candidate cell.

It is to be noted that in the embodiments of the present disclosure, step S61 may be implemented separately or may be implemented together with any of other steps in the embodiments of the present disclosure, for example, together with step S31 and/or step S41 and/or step S51 and step S52 in the embodiments of the present disclosure. The embodiments of the present disclosure have no limitation in this aspect.

According to the embodiments of the present disclosure, in a case where the cell handover message transmitted by the terminal is received by the target cell of the network device but the feedback information from the terminal about the PDSCH previously transmitted by the source cell of the network device has not yet been received, the network device determines that the terminal has not received the PDSCH; and after the terminal completes the switch from the source cell to the target cell, the target cell of the network device transmits/retransmits the data that is not successfully transmitted, to the terminal. Thus, the network device may determine the feedback of the terminal on the PDSCH transmitted by the source cell of the network device before the cell handover message, and the network device may determine whether the PDSCH is successfully transmitted, thereby avoiding data loss or reducing repeated transmission of data.

Refer to FIG. 7, FIG. 7 is a flowchart of a method for feeding back information according to yet another embodiment of the present disclosure. As shown in FIG. 7, the method is performed by a network device and may include, but is not limited to, steps S71 and S72.

Step S71 includes transmitting, through a source cell of the network device or a target cell of the network device, first indication information to a terminal in a case where a cell handover message transmitted by the terminal is received by the target cell of the network device but feedback information from the terminal about a PDSCH previously transmitted by the source cell of the network device has not yet been received. The first indication information is configured to indicate the terminal to transmit the feedback information to the target cell of the network device after the terminal completes the switch from the source cell to the target cell.

In the embodiments of the present disclosure, in a case where the cell handover message transmitted by the terminal being received but the feedback information from the terminal about the previously transmitted PDSCH having not yet been received, the network device may introduce a one shot HARQ ACK report.

The network device may transmit the first indication information to the terminal through the source cell or the target cell. The first indication information is configured to indicate the terminal to transmit the feedback information to the target cell of the network device after the terminal completes the switch from the source cell to the target cell.

In the embodiments of the present disclosure, the first indication information may be Downlink Control Information (DCI) or a medium access control (MAC) control element (CE). The DCI or the MAC CE includes the first indication information.

It may be understood that in the embodiments of the present disclosure, the terminal supports stopping transmission with the source cell while accessing to the target cell, or supports maintaining transmission with the source cell while accessing to the target cell.

In a case where the terminal supports maintaining transmission with the source cell while accessing to the target cell, the network device may transmit second indication information to the terminal through the target cell after the terminal completes the switch from the source cell to the target cell. The second indication information is configured to instruct the terminal to release resources of the source cell.

Based on this, in a case where the terminal supports maintaining transmission with the source cell while accessing to the target cell, the terminal may determine to stop data transmission with the source cell in a case where the second indication information transmitted by the network device is received by the terminal.

It is to be noted that in the embodiments of the present disclosure, the first indication information may be identical with the second indication information. That is, the second indication information may also instruct the terminal to transmit the feedback information to the target cell of the network device after the terminal completes the switch from the source cell to the target cell, or, the first indication information may also instruct the terminal to release the resources of the source cell.

Step S72 includes receiving the feedback information transmitted, after the terminal is switched from the source cell to the target cell, to the target cell of the network device by the terminal according to the first indication information.

In the embodiments of the present disclosure, in a case where the cell handover message transmitted by the terminal is received but the feedback information from the terminal about the previously transmitted PDSCH has not yet been received, the network device transmits the first indication information to the terminal. In this way, the network device may receive the feedback information transmitted, after the terminal is switched from the source cell to the target cell, to the target cell of the network device by the terminal according to the first indication information.

In some embodiments, the network device receives the feedback information transmitted, in a case where the source cell and the target cell are respectively connected to different DUs, to the target cell of the network device by the terminal, where the feedback information includes PDCP SN information.

In the embodiments of the present disclosure, in the case where the source cell and the target cell are respectively connected to different DUs, the network device may receive the feedback information transmitted by the terminal to the target cell of the network device, where the feedback information includes the PDCP SN information.

In the embodiments of the present disclosure, the network device may configure, in advance, at least one candidate cell for the terminal, including related configuration information for the candidate cell, such as a DU to which the candidate cell is connected. The terminal may select the target cell from the at least one candidate cell, and the terminal may determine whether the source cell and the target cell are respectively connected to different DUs according to the related configuration information configured by the network device for the candidate cell.

It is to be noted that in the embodiments of the present disclosure, step S71 and step S72 may be implemented separately or may be implemented together with any of other steps in the embodiments of the present disclosure, for example, together with step S31 and/or step S41 and/or step S51 and step S52 and/or step S61. The embodiments of the present disclosure have no limitation in this aspect.

According to the embodiments of the present disclosure, in a case where the cell handover message transmitted by the terminal is received by the target cell of the network device but the feedback information from the terminal about the PDSCH previously transmitted by the source cell of the network device has not yet been received, the network device determines that the terminal has not received the PDSCH; and after the terminal completes the switch from the source cell to the target cell, the target cell of the network device transmits/retransmits data that is not successfully transmitted, to the terminal. Thus, the network device may determine the feedback of the terminal on the PDSCH transmitted by the source cell of the network device before the cell handover message, and the network device may determine whether the PDSCH is successfully transmitted, thereby avoiding data loss or reducing repeated transmission of data.

Refer to FIG. 8, FIG. 8 is a flowchart of a method for feeding back information according to yet another embodiment of the present disclosure. As shown in FIG. 8, the method is performed by a terminal and may include, but is not limited to, steps S81 and S82.

Step S81 includes transmitting a cell handover message to a target cell of a network device. The cell handover message is configured to indicate that the terminal needs to be switched from a source cell to the target cell.

In the embodiments of the present disclosure, the cell handover message may indicate that the terminal needs to be switched from the source cell to the target cell. The source cell and the target cell may be connected to a same DU or may be respectively connected to different DUs. The embodiments of the present disclosure have no limitation in this aspect.

In the embodiments of the present disclosure, the terminal transmits the cell handover message to the target cell of the network device, and the cell handover message may be a random access channel (RACH) initiated by the terminal to the target cell of the network device or a dedicated/specific message transmitted by the terminal to the target cell of the network device.

Step S82 includes determining to perform a specific processing flow to feed back feedback information about a PDSCH previously transmitted by the source cell of the network device, in a case where the feedback information about the PDSCH previously transmitted by the source cell of the network device has not yet been fed back.

In the embodiments of the present disclosure, the terminal determines to perform the specific processing flow to feed back the feedback information about the PDSCH previously transmitted by the source cell of the network device, in a case where the feedback information about the PDSCH previously transmitted by the source cell of the network device has not yet been fed back.

In some implementations, the terminal determining to perform the specific processing flow may include determining to cancel transmitting the feedback information to the source cell or the target cell of the network device.

In the embodiments of the present disclosure, in a case where the terminal determines to cancel transmitting the feedback information to the source cell or the target cell of the network device, the network device may determine by default that the terminal has successfully received the PDSCH or may determine by default that the terminal fails to successfully receive the PDSCH.

For example, the network device may determine by default that the feedback information from the terminal about the previously transmitted PDSCH is received, and the feedback information is acknowledge (ACK) information/message.

For example, the network device may determine by default that the feedback information from the terminal about the previously transmitted PDSCH is received, and the feedback information is not acknowledge (NACK) information/message.

In a case where the network device determines by default that the terminal has not received the PDSCH, the network device may retransmit data that is not successfully transmitted, to the terminal through the target cell after the terminal competes the cell switch.

In some other implementations, the terminal determining to perform the specific processing flow may include transmitting the feedback information to the target cell of the network device after completing the switch from the source cell to the target cell.

In some embodiments, the terminal maintains or stops at least one of an uplink data transmission or a downlink data transmission with the source cell of the network device while accessing to the target cell.

In the embodiments of the present disclosure, the terminal supports maintaining data transmission with the source cell of the network device while accessing to the target cell.

Based on this, the network device may maintain at least one of the uplink data transmission or the downlink data transmission through the source cell in a case where the cell handover message transmitted by the terminal is received through the target cell.

In an embodiment of the present disclosure, the terminal does not support maintaining data transmission with the source cell of the network device while accessing to the target cell, and stops at least one of the uplink data transmission or the downlink data transmission with the source cell of the network device.

In some embodiments, the terminal, after completing the switch from the source cell to the target cell, receives second indication information transmitted by the target cell of the network device. The second indication information is configured to instruct the terminal to release resources of the source cell.

In the embodiments of the present disclosure, the terminal, after completing the switch from the source cell to the target cell, may receive the second indication information transmitted by the target cell of the network device. The second indication information is configured to instruct the terminal to release the resources of the source cell. Based on this, the terminal may release the resources of the source cell and stop at least one of the uplink data transmission or the downlink data transmission with the source cell in a case where the second indication information is received by the terminal.

In some embodiments, the terminal stops at least one of the uplink data transmission or the downlink data transmission with the source cell of the network device according to the second indication information, in the case where the terminal maintains data transmission with the source cell of the network device while accessing to the target cell.

It may be understood that in a case where the terminal supports maintaining data transmission with the source cell of the network device while accessing to the target cell, the terminal, after completing the switch from the source cell to the target cell, may receive the second indication information transmitted by the target cell of the network device. The second indication information is configured to instruct the terminal to release the resources of the source cell.

The terminal receives the second indication information transmitted by the target cell of the network device. The terminal may stop at least one of the uplink data transmission or the downlink data transmission with the source cell of the network device according to the second indication information, in a case where the terminal supports maintaining data transmission with the source cell of the network device while accessing to the target cell.

According to the embodiments of the present disclosure, the terminal transmits the cell handover message to the target cell of the network device, and the cell handover message is configured to indicate that the terminal needs to be switched from the source cell to the target cell; and the terminal determines to perform the specific processing flow to feed back the feedback information about the PDSCH previously transmitted by the source cell of the network device, in a case where the feedback information about the PDSCH previously transmitted by the source cell of the network device has not yet been fed back. Thus, the terminal may feed back the feedback information about the PDSCH previously transmitted by the source cell of the network device, the network device may determine the feedback of the terminal on the PDSCH transmitted by the source cell of the network device before the cell handover message, and the network device may determine whether the PDSCH is successfully transmitted, thereby avoiding data loss or reducing repeated transmission of data.

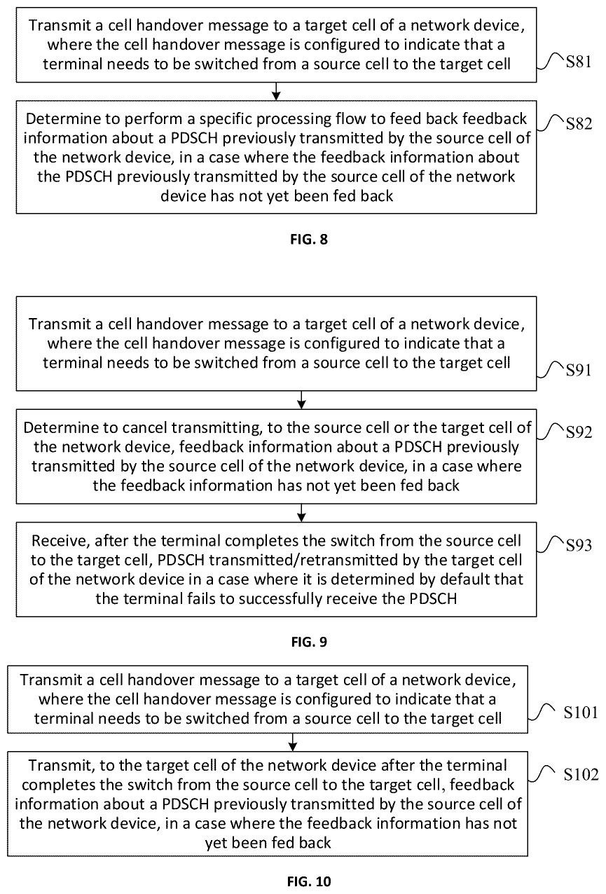

Refer to FIG. 9, FIG. 9 is a flowchart of a method for feeding back information according to yet another embodiment of the present disclosure. As shown in FIG. 9, the method is performed by a terminal and may include, but is not limited to, steps S91, S92, and S93.

Step S91 includes transmitting a cell handover message to a target cell of a network device. The cell handover message is configured to indicate that the terminal needs to be switched from a source cell to the target cell.

Step S92 includes determining to cancel transmitting, to the source cell or the target cell of the network device, feedback information about a PDSCH previously transmitted by the source cell of the network device, in a case where the feedback information has not yet been fed back.

In the embodiments of the present disclosure, for a related description of step S91 and step S92, reference may be made to the related description in other embodiments, which will not be repeated here.

Step S93 includes receiving after the terminal completes the switch from the source cell to the target cell, data that is not successfully transmitted, transmitted/retransmitted by the target cell of the network device in a case where it is determined by default that the terminal fails to successfully receive the PDSCH.

In the embodiments of the present disclosure, in a case where the terminal determines to cancel transmitting, to the source cell or the target cell of the network device, the feedback information about the PDSCH previously transmitted by the source cell of the network device in the case where the feedback information has not yet been fed back, the network device may determine by default that the terminal has received the PDSCH or determine by default that the terminal has not received the PDSCH.

For example, the network device may determine by default that the feedback information from the terminal about the previously transmitted PDSCH is received, and the feedback information is acknowledge (ACK) information/message.

For example, the network device may determine by default that the feedback information from the terminal about the previously transmitted PDSCH is received, and the feedback information is not acknowledge (NACK) information/message.

In a case where the network device determines by default that the terminal has not received the PDSCH, the network device may retransmit data that is not successfully transmitted, to the terminal through the target cell or transmit corresponding data to the terminal through the target cell after the terminal completes the cell switch.

Based on this, the terminal, after completing the switch from the source cell to the target cell, may receive the PDSCH transmitted/retransmitted by the target cell of the network device or the corresponding data transmitted by the target cell of the network device in a case where it is determined by default that the terminal has not received the PDSCH.

In the embodiments of the present disclosure, the cell handover message may indicate that the terminal needs to be switched from the source cell to the target cell. The source cell and the target cell may be connected to a same DU or may be respectively connected to different DUs. The embodiments of the present disclosure have no limitation in this aspect.

It may be understood that in a case where the source cell and the target cell are connected to a same DU, the target cell and the source cell of the network device share a same physical layer, a same MAC layer and a same RLC layer. Thus, the target cell may retransmit the data that is not successfully transmitted, to the terminal.

It may be understood that in a case where the source cell and the target cell are respectively connected to different DUs, physical layers and MAC layers of the target cell and the source cell of the network device are different, the source cell may transmit an SN state message to the target cell, the target cell may perform data transmission according to the SN state message, and may retransmit a PDCP SDU/PDU, that is determined by default to be not successfully transmitted by the source cell.

It is to be noted that in the embodiments of the present disclosure, step S91 and step S93 may be implemented separately or may be implemented together with any of other steps in the embodiments of the present disclosure, for example, together with step S81 and step S82 in the embodiments of the present disclosure. The embodiments of the present disclosure have no limitation in this aspect.

According to the embodiments of the present disclosure, the terminal transmits the cell handover message to the target cell of the network device, where the cell handover message is configured to indicate that the terminal needs to be switched from the source cell to the target cell; and the terminal determines to cancel transmitting, to the source cell or the target cell of the network device, the feedback information about the PDSCH previously transmitted by the source cell of the network device in the case where the feedback information has not yet been fed back. Thus, the terminal may feed back the feedback information about the PDSCH transmitted by the source cell of the network device, the network device may determine the feedback of the terminal on the PDSCH transmitted by the source cell of the network device before the cell handover message, and the network device may determine whether the PDSCH is successfully transmitted, thereby avoiding data loss or reducing repeated transmission of data.

Referring to FIG. 10, FIG. 10 is a flowchart of a method for feeding back information according to yet another embodiment of the present disclosure. As shown in FIG. 10, the method is performed by a terminal and may include, but is not limited to, steps S101 and S102.

Step S101 includes transmitting a cell handover message to a target cell of a network device. The cell handover message is configured to indicate that the terminal needs to be switched from a source cell to the target cell.

Step S102 includes transmitting, to the target cell of the network device after the terminal completes the switch from the source cell to the target cell, feedback information about a PDSCH previously transmitted by the source cell of the network device, in a case where the feedback information has not yet been fed back.

In the embodiments of the present disclosure, for a related description of step S101, reference may be made to the related description in other embodiments, which will not be repeated here.

In the embodiments of the present disclosure, in a case where the feedback information about the PDSCH previously transmitted by the source cell of the network device has not yet been fed back after the terminal transmits the cell handover message to the target cell of the network device, the terminal may transmit the feedback information to the target cell of the network device after completing the switch from the source cell to the target cell.

In the embodiments of the present disclosure, the cell handover message may indicate that the terminal needs to be switched from the source cell to the target cell. The source cell and the target cell may be connected to a same DU or may be respectively connected to different DUs. The embodiments of the present disclosure have no limitation in this aspect.

In some embodiments, transmitting, by the terminal, the feedback information to the target cell of the network device includes: transmitting the feedback information to the target cell of the network device, where the feedback information includes PDCP SN information.

In the embodiments of the present disclosure, transmitting, by the terminal, the feedback information to the target cell of the network device may include: transmitting the feedback information to the target cell of the network device, where the feedback information includes the PDCP SN information.

In some embodiments, the terminal transmits the feedback information to the target cell of the network device in a case where the source cell and the target cell are respectively connected to different DUs, where the feedback information includes the PDCP SN information.

In the embodiments of the present disclosure, in the case where the source cell and the target cell are respectively connected to different DUs, the terminal may transmit the feedback information to the target cell of the network device, where the feedback information includes the PDCP SN information.

In the embodiments of the present disclosure, the network device may configure, in advance, at least one candidate cell for the terminal, including related configuration information for the candidate cell, such as a DU to which the candidate cell is connected. The terminal may select the target cell from the at least one candidate cell, and the terminal may determine whether the source cell and the target cell are respectively connected to different DUs according to the related configuration information configured by the network device for the candidate cell.

It is to be noted that in the embodiments of the present disclosure, step S101 and step S102 may be implemented separately or may be implemented together with any of other steps in the embodiments of the present disclosure, for example, together with step S81 and step S82 and/or step S91 to step S93 in the embodiments of the present disclosure. The embodiments of the present disclosure have no limitation in this aspect.

According to the embodiments of the present disclosure, the terminal transmits the cell handover message to the target cell of the network device, where the cell handover message is configured to indicate that the terminal needs to be switched from the source cell to the target cell; and the terminal determines to cancel transmitting, to the source cell or the target cell of the network device, the feedback information about the PDSCH previously transmitted by the source cell of the network device in the case where the feedback information has not yet been fed back. Thus, the terminal may feed back the feedback information about the PDSCH transmitted by the source cell of the network device, the network device may determine the feedback of the terminal on the PDSCH transmitted by the source cell of the network device before the cell handover message, and the network device may determine whether the PDSCH is successfully transmitted, thereby avoiding data loss or reducing repeated transmission of data.

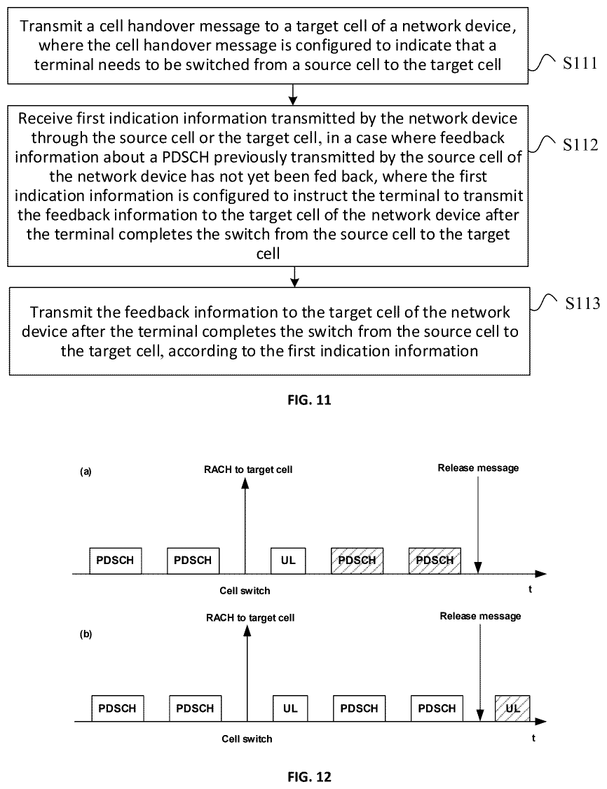

Referring to FIG. 11, FIG. 11 is a flowchart of a method for feeding back information according to yet another embodiment of the present disclosure. As shown in FIG. 11, the method is performed by a terminal and may include, but is not limited to, steps S111, S112, and S113.

Step S111 includes transmitting a cell handover message to a target cell of a network device. The cell handover message is configured to indicate that the terminal needs to be switched from a source cell to the target cell.

In the embodiments of the present disclosure, for a related description of S111, reference may be made to the related description in other embodiments, which will not be repeated here.

Step S112 includes receiving first indication information transmitted by the network device through the source cell or the target cell, in a case where feedback information about a PDSCH previously transmitted by the source cell of the network device has not yet been fed back. The first indication information is configured to instruct the terminal to transmit the feedback information to the target cell of the network device after the terminal completes the switch from the source cell to the target cell.

In the embodiments of the present disclosure, in a case where the terminal has not fed back the feedback information about the PDSCH previously transmitted by the source cell of the network device after transmitting the cell handover message to the target cell of the network device, the terminal receives the first indication information transmitted by the network device through the source cell or the target cell. The first indication information is configured to instruct the terminal to transmit all the feedback information about the PDSCH to the target cell of the network device after the terminal completes the switch from the source cell to the target cell.

The feedback information is ranked according to HARQ process ID of the PDSCH and feeds back corresponding ACK/NACK information.

The feedback information includes PDCP SN information, including ACK/NACK information corresponding to the corresponding PDCP SN (i.e., information about whether transmission succeeds).

The terminal may receive the first indication information transmitted by the network device through the source cell or the target cell, and the first indication information is configured to instruct the terminal to transmit the feedback information to the target cell of the network device after the terminal completes the switch from the source cell to the target cell.

In the embodiments of the present disclosure, the first indication information may be DCI or a MAC CE. The DCI or the MAC CE includes the first indication information.

It may be understood that in the embodiments of the present disclosure, the terminal does not support maintaining transmission with the source cell while accessing to the target cell or supports maintaining transmission with the source cell while accessing to the target cell.

In a case where the terminal supports maintaining transmission with the source cell while accessing to the target cell, the network device may transmit second indication information to the terminal through the target cell after the terminal completes the switch from the source cell to the target cell. The second indication information is configured to instruct the terminal to release resources of the source cell.

Based on this, in the case where the terminal supports maintaining transmission with the source cell while accessing to the target cell, the terminal may determine to stop data transmission with the source cell in a case where the second indication information transmitted by the network device is received by the terminal.

It is to be noted that in the embodiments of the present disclosure, the first indication information may be identical with the second indication information. That is, the second indication information may instruct the terminal to transmit the feedback information to the target cell of the network device after the terminal completes the switch from the source cell to the target cell, or, the first indication information may instruct the terminal to release the resources of the source cell.

Step S113 includes transmitting the feedback information to the target cell of the network device after the terminal completes the switch from the source cell to the target cell, according to the first indication information.

In the embodiments of the present disclosure, in a case where the terminal has not fed back the feedback information about the PDSCH previously transmitted by the source cell of the network device after transmitting the cell handover message to the target cell of the network device, the terminal may receive the first indication information transmitted by the network device. According to the first indication information, the terminal may transmit the feedback information to the target cell of the network device after being switched from the source cell to the target cell.

In some embodiments, in a case where the source cell and the target cell are respectively connected to different DUs, the terminal transmits the feedback information to the target cell of the network device, where the feedback information includes PDCP SN information.

In the embodiments of the present disclosure, in the case where the source cell and the target cell are respectively connected to different DUs, the terminal may transmit the feedback information to the target cell of the network device, where the feedback information includes the PDCP SN information.

In the embodiments of the present disclosure, the network device may configure, in advance, at least one candidate cell for the terminal, including related configuration information for the candidate cell, such as a DU to which the candidate cell is connected. The terminal may select the target cell from the at least one candidate cell, and the terminal may determine whether the source cell and the target cell are respectively connected to different DUs according to the related configuration information configured by the network device for the candidate cell.

It is to be noted that in the embodiments of the present disclosure, step S111 to step S113 may be implemented separately or may be implemented together with any of other steps in the embodiments of the present disclosure, for example, together with step S81 and step S82 and/or step S91 to step S93 and/or step S101 to step S102 in the embodiments of the present disclosure. The embodiments of the present disclosure have no limitation in this aspect.

According to the embodiments of the present disclosure, the terminal transmits the cell handover message to the target cell of the network device, where the cell handover message is configured to indicate that the terminal needs to be switched from the source cell to the target cell; the terminal receives the first indication information transmitted by the network device through the source cell or the target cell, in a case where the feedback information about the PDSCH previously transmitted by the source cell of the network device has not yet been fed back, where the first indication information is configured to instruct the terminal to transmit the feedback information to the target cell of the network device after the terminal completes the switch from the source cell to the target cell; and the terminal, after being switched from the source cell to the target cell, transmits the feedback information to the target cell of the network device according to the first indication information. Thus, the terminal may feed back the feedback information about the PDSCH transmitted by the source cell of the network device, the network device may determine the feedback of the terminal on the PDSCH transmitted by the source cell of the network device before the cell handover message, and the network device may determine whether the PDSCH is successfully transmitted, thereby avoiding data loss or reducing repeated transmission of data.

For a good understanding of the embodiments of the present disclosure, the following example is provided. It may be understood that the example is merely illustrative and is not to be construed as a limitation to the embodiments of the present disclosure.

In the example, a user (a terminal, the same below) supports maintaining transmission with a source cell while accessing to a target cell.

For an intra-DU scenario (the source cell and the target cell are connected to a same DU):

Option 1: after the DU receives a handover message (RACH or other dedicated message) from the user, the source cell may stop new downlink transmission. After the cell switch succeeds, the DU may transmit a displayed message to the user to allow the user to release resources of the source cell, and the user, after receiving the message, may stop data transmission with the source cell.

For a PDSCH without ACK feedback information, the network device determines by default that the feedback information is NACK or ACK. As shown in FIG. 12(a), there will be no new PDSCH after the cell switch is completed. In a case where there may be a PDSCH without feedback information, the quantity of retransmitted/discarded data will not be too large.

Option 2: after the DU receives a handover message from the user, the source cell still performs new downlink transmission. After the cell switch succeeds, the source cell stops data transmission with the user; in addition, the target cell transmits a displayed message to the user to allow the user to release resources of the source cell, and the user, after receiving the message, stops data transmission with the source cell.

As shown in FIG. 12(b), there may be many PDSCHs without ACK feedback information, and in this case, a one shot HARQ ACK report is introduced. This may be triggered by the target cell through DCI or may be triggered by a release message.

For an inter-DU scenario (the source cell and the target cell are respectively connected to different DUs):

After the user is accessed to the target cell, a CU feeds back a handover success message to a source DU. After receiving the handover success message, the source DU may stop downlink data transmission.

For a PDSCH without ACK feedback information, the feedback information is determined by default as NACK or ACK. In a case where the feedback information is NACK, the PDCP SDU is retransmitted. That is, SN states fed back to the target cell is the PDCP SDU that is determined by default to be not successfully transmitted.

In the example, the user (the terminal, the same below) may stop transmission with the source cell while accessing to the target cell.

For the intra-DU scenario (the source cell and the target cell are connected a same DU):

After the DU receives a handover message from the user, the source cell stops downlink data transmission.

A one shot HARQ ACK report is introduced. This is triggered by the target cell through DCI. A codebook is generated according to the sequence of HARQ process IDs.

For the inter-DU scenario (the source cell and the target cell are respectively connected to different DUs):

The source cell stops downlink data transmission after receiving a handover success message.

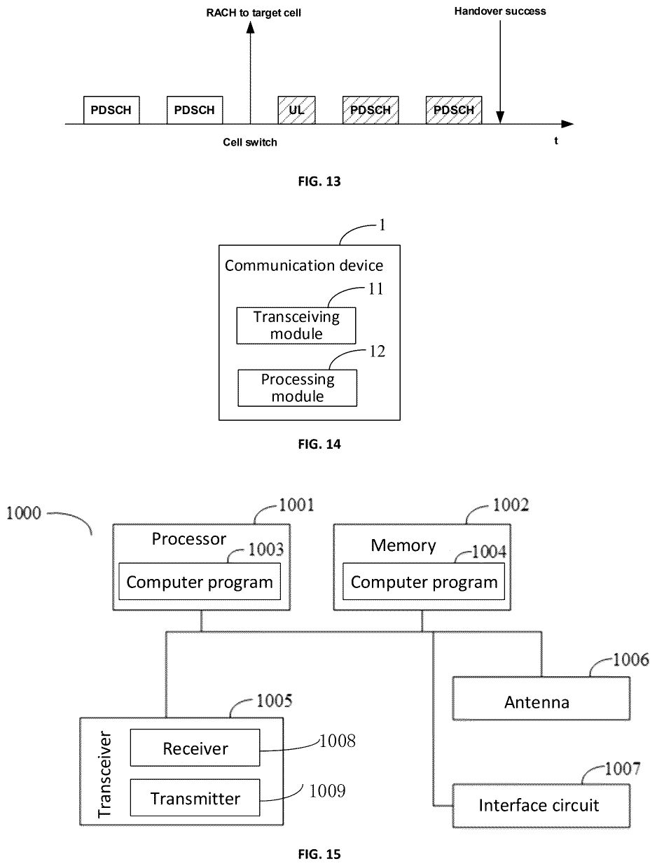

In this case, as shown in FIG. 13, after the target cell is accessed to and before the handover success message from the CU is received, the source cell may still transmit downlink data, but the UE has stopped receiving downlink data, such that this part of data is lost.

One manner for handling this problem is to retransmit the PDCP SDU by the target cell for all data that the ACK message has not been received.

Another manner for handling this problem is to introduce a one shot HARQ ACK feedback to retransmit the ACK information to the target cell. In this case, a manner for the target cell to recognize a corresponding relation between the ACK information and the PDSCHs in the HARQ codebook needs to be designed. One manner is to adopt a processing manner as used in the intra-DU scenario, but the target cell needs to be informed with the corresponding relation between PDUs and HARQ process IDs of the source cell. Another manner is to rank the ACK information according to hyper frame number (HFN) and SN information when generating the HARQ-ACK codebook.

The embodiments of the present disclosure provide an HARQ-ACK message feedback and data retransmission method, which is mainly applied to the L1/L2 based inter-cell mobility scenario proposed in R18, so as to reduce the possibility of data loss and reduce repeated transmission of data.

In the above-mentioned embodiments of the present disclosure, the method provided by the embodiments of the present disclosure is introduced respectively from the perspective of the network device and from the perspective of the terminal.

Referring to FIG. 14, FIG. 14 is a schematic structural diagram of a communication device 1 according to an embodiment of the present disclosure. The communication device 1 shown in FIG. 14 may include a transceiving module 11 and a processing module 12. The transceiving module 11 may include at least one of a transmitting module (not shown) or a receiving module (not shown). The transmitting module is configured to realize a transmitting function, the receiving module is configured to realize a receiving function, and the transceiving module 11 may realize at least one of the transmitting function or the receiving function.

The communication device 1 may be a terminal, a device in the terminal, or a device used together with the terminal. Alternatively, the communication device 1 may be a network device, a device in the network device, or a device used together with the network device.

For a case where the communication device 1 is configured at the side of the network device.

The communication device 1 includes the transceiving module 11 and the processing module 12.

The processing module 12 is configured to determine a feedback of a terminal on a PDSCH previously transmitted by a source cell of the network device, in a case where a cell handover message transmitted by the terminal is received by a target cell of the network device but feedback information from the terminal about the PDSCH has not yet been received.

In some embodiments, the processing module 12 is further configured to determine that the terminal has received the PDSCH, or determine that the terminal has not received the PDSCH, or receive the feedback information transmitted, after the terminal is switched from the source cell to the target cell, to the target cell of the network device by the terminal.

In some embodiments, the transceiving module 11 is configured to transmit/retransmit, in a case of determining that the terminal has not received the PDSCH, data that is not successfully transmitted, to the target cell of the network device after the terminal completes the switch from the source cell to the target cell.

In some embodiments, the transceiving module 11 is configured to receive the feedback information transmitted, after the terminal is switched from the source cell to the target cell, to the target cell of the network device by the terminal, where the feedback information includes PDCP SN information.

In some embodiments, the transceiving module 11 is configured to transmit first indication information to the terminal through the source cell or the target cell. The first indication information is configured to instruct the terminal to transmit the feedback information to the target cell of the network device after the terminal completes the switch from the source cell to the target cell.

In some embodiments, the transceiving module 11 is configured to receive the feedback information transmitted, after the terminal is switched from the source cell to the target cell, to the target cell of the network device by the terminal according to the first indication information.

In some embodiments, the transceiving module 11 is configured to receive the feedback information transmitted, in a case where the source cell and the target cell are respectively connected to different DUs, to the target cell of the network device by the terminal, where the feedback information includes PDCP SN information.

In some embodiments, the transceiving module 11 is configured to stop or continue downlink data transmission through the source cell in a case where the cell handover message transmitted by the terminal is received through the target cell.

In some embodiments, the transceiving module 11 is configured to determine to stop downlink data transmission through the source cell in a case of the cell handover message transmitted by the terminal being received through the target cell and determining that the terminal completes the switch from the source cell to the target cell.

In some embodiments, the transceiving module 11 is configured to transmit second indicative message to the terminal through the target cell after the terminal completes the switch from the source cell to the target cell. The second indication information is configured to instruct the terminal to release resources of the source cell.

For a case where the communication device 1 is configured at the side of the terminal.

The communication device 1 includes the transceiving module 11 and the processing module 12.

The transceiving module 11 is configured to transmit a cell handover message to a target cell of a network device. The cell handover message is configured to indicate that the terminal needs to be switched from a source cell to the target cell.

The processing module 12 is configured to determine to perform a specific processing flow to feed back feedback information about a PDSCH previously transmitted by the source cell of the network device, in a case where the feedback information about the PDSCH previously transmitted by the source cell of the network device has not yet been fed back.

In some embodiments, the processing module 12 is further configured to determine to cancel transmitting the feedback information to the source cell or the target cell of the network device or transmit the feedback information to the target cell of the network device after the terminal completes the switch from the source cell to the target cell.

In some embodiments, the transceiving module 11 is further configured to receive after the terminal completes the switch from the source cell to the target cell, in a case of determining by the terminal to cancel transmitting the feedback information to the source cell or the target cell of the network device, data that is not successfully transmitted, transmitted/retransmitted by the target cell of the network device in a case where it is determined by default that the terminal has not received the PDSCH.

In some embodiments, the transceiving module 11 is further configured to transmit the feedback information to the target cell of the network device, where the feedback information includes PDCP SN information.

In some embodiments, the transceiving module 11 is further configured to receive first indication information transmitted by the network device through the source cell or the target cell. The first indication information is configured to instruct the terminal to transmit the feedback information to the target cell of the network device after the terminal completes the switch from the source cell to the target cell.

In some embodiments, the transceiving module 11 is further configured to transmit the feedback information to the target cell of the network device after the terminal completes the switch from the source cell to the target cell, according to the first indication information.

In some embodiments, the transceiving module 11 is further configured to transmit the feedback information to the target cell of the network device in a case where the source cell and the target cell are respectively connected to different DUs, where the feedback information includes PDCP SN information.

In some embodiments, the transceiving module 11 is further configured to maintain or stop at least one of an uplink data transmission or a downlink data transmission with the source cell of the network device while accessing to the target cell.

In some embodiments, the transceiving module 11 is further configured to receive second indication information transmitted by the target cell of the network device after the terminal completes the switch from the source cell to the target cell. The second indication information is configured to instruct the terminal to release resources of the source cell.

In some embodiments, the transceiving module 11 is further configured to stop at least one of the uplink data transmission or the downlink data transmission with the source cell of the network device according to the second indication information, in a case where the terminal maintains data transmission with the source cell of the network device while accessing to the target cell.

Operations performed by the modules of the communication device 1 in the embodiments have been described in detail in the embodiments of the method and will not be expounded here.

The beneficial effects fulfilled by the communication device 1 provided in the embodiments of the present disclosure are identical or similar to the beneficial effects of the method for feeding back information provided in some of the embodiments, and will not be repeated here.

Referring to FIG. 15, FIG. 15 is a schematic structural diagram of a communication device 1000 according to another embodiment of the present disclosure. The communication device 1000 may be a terminal; a network device; a chip, a chip system or a processor supporting the terminal in implementing the method for feeding back information; or a chip, a chip system or a processor supporting the network device in implementing the method for feeding back information; or the like. The communication device 1000 may be configured to implement the method described in the method embodiments and may be understood with reference to the description in the method embodiments.

The communication device 1000 may include one or more processors 1001. The processor 1001 may be a general-purpose processor, a special-purpose processor, or the like. For example, the processor 1001 may be a baseband processor or a central processing unit. The baseband processor may be configured to process communication protocols and communication data. The central processing unit may be configured to control a communication device (such as, a network device, a baseband chip, a terminal, a terminal chip, a DU, a CU, or the like), execute a computer program and process data of the computer program.

In an example, the communication device 1000 may further include one or more memories 1002, storing a computer program 1004. The memory 1002 executes the computer program 1004 to cause the communication device 1000 to perform the method described in the method embodiments. In an example, the memory 1002 may also store data. The communication device 1000 and the memory 1002 may be arranged separately or may be integrated.

In an example, the communication device 1000 may further include a transceiver 1005 and an antenna 1006. The transceiver 1005 may be referred to as a transceiving unit, a transceiving machine, a transceiving circuit or the like and is configured to realize a transceiving function. The transceiver 1005 may include a receiver 1008 and a transmitter 1009. The receiver 1008 may be referred to as a receiving machine, a receiving circuit or the like and is configured to realize a receiving function. The transmitter 1009 may be referred to as a transmitting machine, a transmitting circuit or the like and is configured to realize a transmitting function.

In an example, the communication device 1000 may further include one or more interface circuits 1007. The interface circuit 1007 is configured to receive code instructions and transmit the code instructions to the processor 1001. The processor 1001 runs the code instructions to cause the communication device 1000 to perform the method described in the method embodiments.

For a case where the communication device 1000 is a network device: the transceiver 1005 and the processor 1001 are configured to perform the steps in FIG. 3 to FIG. 7 and FIG. 12 to FIG. 13.

For a case where the communication device 1000 is a terminal: the transceiver 1005 and the processor 1001 are configured to perform the steps in FIG. 8 to FIG. 13.

In an implementation, the processor 1001 may include a transceiver (not shown) configured to realize a receiving and transmitting function. For example, the transceiver may be a transceiving circuit, an interface or an interface circuit. The transceiving circuit, interface or interface circuit for realizing the receiving function and the transmitting function may be separated or integrated. The transceiving circuit, the interface or the interface circuit may be configured to read and write codes/data, or the transceiving circuit, the interface or the interface circuit may be configured to transmit or transfer a signal.

In an implementation, the processor 1001 may store a computer program 1003. The computer program 1003 runs on the processor 1001 to cause the communication device 1000 to perform the method described in the method embodiments. The computer program 1003 may be cured in the processor 1001, and in this case, the processor 1001 may be realized by hardware.

In an implementation, the communication device 1000 may include a circuit (not shown). The circuit may realize the transmitting function, the receiving function or the communication function in the method embodiments. The processor and transceiver described in the present disclosure may be realized on an integrated circuit (IC), an analog IC, a radio frequency integrated circuit (RFIC), a mixed-signal IC, an application specific integrated circuit (ASIC), a printed circuit board (PCB), an electronic device, or the like. The processor and the transceiver may also be manufactured by various IC processes, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), and the like.

The communication device described in the embodiments may be a terminal or a network device, the scope of the communication device described in the present disclosure is not limited to this, and the structure of the communication device may not be limited by FIG. 15. The communication device may be a stand-alone device or a part of a large device. For example, the communication device may be:
(1) a stand-alone IC, a chip, a chip system or a sub-system;
(2) a set with one or more ICs, and in an example, the IC set may also include a storage component for storing data and a computer program;
(3) an ASIC, such as a Modem;
(4) a module embedded in other devices;
(5) a receiver, a terminal, a smart terminal, a cell phone, a wireless device, a handset, a mobile unit, a vehicle-mounted device, a network device, a cloud device, an artificial intelligence device, etc. ;
(6) and the like.

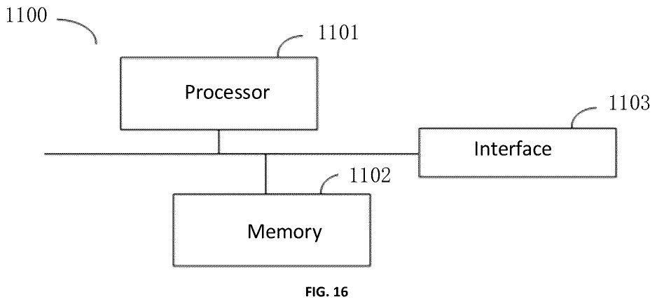

For a case where the communication device may be a chip or a chip system, referring to FIG. 16, FIG. 16 is a structural diagram of a chip according to an embodiment of the present disclosure.

The chip 1100 includes a processor 1101 and an interface 1103. One or more processors 1101 may be configured, and a plurality of interfaces 1103 may be configured.

For a case where the chip 1100 is configured to realize the functions of the terminal in the embodiments of the present disclosure:
the interface 1103 is configured to receive code instructions and transmit the code instructions to the processor 1101;
the processor 1101 is configured to run the code instructions to implement the method for feeding back information according to some of the embodiments.

For a case where the chip 1100 is configured to realize the functions of the network device in the embodiments of the present disclosure:
the interface 1103 is configured to receive code instructions and transmit the code instructions to the processor 1101;
the processor 1101 is configured to run the code instructions to implement the method for feeding back information according to some of the embodiments.

In an example, the chip 1100 further includes a memory 1102. The memory 1102 is configured to store necessary computer programs and data.

Those skilled in the art may understand that various illustrative logic blocks and steps listed in the embodiments of the present disclosure may be realized by electronic hardware, computer software, or a combination of the electronic hardware and computer software. Whether these functions are realized by hardware or software depends on specific applications and design requirements of a whole system. For each specific application, those skilled in the art may realize these functions through various methods, and this is not to be construed as exceeding the protection scope of the embodiments of the present disclosure.

The embodiments of the present disclosure further provide a system for feeding back information. The system for feeding back information includes the communication device used as the terminal and the communication device used as the network device in the embodiment shown in FIG. 14. Alternatively, the system for feeding back information includes the communication device used as the terminal and the communication device used as the network device in the embodiment shown in FIG. 15.

The present disclosure further provides a non-transitory computer-readable storage medium, storing instructions, where the instructions, when executed by a computer, realize the functions in any one of the method embodiments.

The present disclosure further provides a computer program product, where the computer program product, when executed by a computer, realizes the functions in any one of the method embodiments.

All or part of the functions in the embodiments may be realized by software, hardware, firmware or any combinations of the software, the hardware and the firmware. In a case where the functions are realized by software, all or part of the functions may be realized in the form of a computer program product. The computer program product includes one or more computer programs. When the computer program is loaded and executed on a computer, all or part of the flows or functions according to the embodiments of the present disclosure are produced. The compute may be a general-purpose computer, a specific-purpose computer, a computer network, or other programmable devices. The computer program may be stored in a non-transitory computer-readable storage medium or transmitted by one non-transitory computer-readable storage medium to another non-transitory computer-readable storage medium, for example, the computer program may be transmitted by one website, computer, server or data center to another website, computer, server or data center in a wired manner (for example, through a coaxial cable, an optical fiber, or a digital subscriber line (DSL)) or in a wireless manner (for example, by infrared rays, radio, microwaves, etc.). The non-transitory computer-readable storage medium may be any computer-accessible available medium, or a data storage device including one or more available media, such as a server or a data center. The available medium may be a magnetic medium (such as, a floppy disk, a hard disk or a magnetic tape), an optical medium (such as, a high-density digital video disc (DVD)), or a semiconductor medium (such as, a solid state disk (SSD)).

Those ordinarily skilled in the art may appreciate that various numerical symbols such as first and second in the present disclosure are merely for distinguishing for the convenience of description and are not used to limit the scope of the embodiments of the present disclosure, and the numerical symbols also indicate an order of precedence.

“At least one” in the present disclosure may also be described as “one” or “a plurality of”. “A plurality of” may be “two,” “three,” “four” or more. The present disclosure has no limitation in this aspect. In the embodiments of the present disclosure, “first,” “second,” “third,” “A,” “B,” “C” and “D” are used to distinguish technical features, and the technical features described with “first,” “second,” “third,” “A,” “B,” “C” and “D” do not have an order of precedence or an order of size.

Depending on the context, terms “if” and “as if” used in the present disclosure may be appreciated as “in a case where,” “when” or “in response to determining”.

The corresponding relations illustrated by the tables in the present disclosure may be configured or predefined. Values of information in the tables are merely illustrative, and other values may be configured for the information. The present disclosure has no limitation in this aspect. In a case where the corresponding relation between information and parameters is configured, it is not definitely necessary to configure all the corresponding relations illustrated in the tables. For example, the corresponding relations illustrated by some rows of the tables in the present disclosure may not be configured. For another example, suitable transformations and adjustments, such as splitting and combination, may be made based on the tables. The names of parameters illustrated in the titles of the tables may be replaced with other names understandable for the communication device, and the values or expressions of the parameters may also be replaced with other values or expressions understandable for the communication device. The tables may also be realized through other data structures, for example, through an array, a queue, a container, a stack, a linear list, a pointer, a chain table, a tree, a diagram, a structural body, a category, a pile, a hash table, or the like.

“Predefine” in the present disclosure may be interpreted as “define,” “define in advance,” “store,” “pre-store,” “pre-agree,” “pre-configure,” “cure” or “pre-fire”.

As used herein, the term “processor” may refer to one processor that performs the defined functions or a plurality of processors that collectively perform defined functions, such that the execution of the individual defined functions may be divided amongst such processors

Those ordinarily skilled in the art may appreciate that units and arithmetic steps of the examples described in conjunction with the embodiments of the present disclosure may be realized by electronic hardware or the combination of computer software and the electronic hardware. Whether these functions are realized by hardware or software depends on specific applications and design requirements of a whole system. For each specific application, those skilled in the art may realize these functions through various methods, and this is not to be construed as exceeding the scope of the present disclosure.

Those skilled in the art may clearly understand that for the convenience and brevity of description, the specific operating process of the system, device and unit described may be understood with reference to the corresponding process in the method embodiments and will not be repeated here.

The embodiments described are merely specific ones of the present disclosure, and the protection scope of the present disclosure is not limited to the embodiments. All transformations or substitutions easily obtained by any skilled in the art within the technical scope of the present disclosure is to fall within the protection scope of the present disclosure. Thus, the protection scope of the present disclosure is defined by the protection scope of the claims.

1. A method for feeding back information, performed by a network device, the method comprising:
determining a feedback of a terminal on a physical downlink shared channel (PDSCH) previously transmitted by a source cell of the network device, in a case where a cell handover message transmitted by the terminal is received by a target cell of the network device but feedback information from the terminal about the PDSCH has not yet been received.

2. The method according to claim 1, wherein determining the feedback of the terminal on the PDSCH comprises one of the following:
determining that the terminal has received the PDSCH;
determining that the terminal has not received the PDSCH; or
receiving the feedback information transmitted, after the terminal is switched from the source cell to the target cell, to the target cell of the network device by the terminal.

3. The method according to claim 2, further comprising:
transmitting/retransmitting to the terminal, by the target cell of the network device, data that is not successfully transmitted after the terminal completes a switch from the source cell to the target cell, in a case of determining that the terminal has not received the PDSCH.

4. The method according to claim 2, wherein receiving the feedback information transmitted, after the terminal is switched from the source cell to the target cell, to the target cell of the network device by the terminal comprises:
receiving the feedback information transmitted, after the terminal is switched from the source cell to the target cell, to the target cell of the network device by the terminal, wherein the feedback information comprises packet data convergence protocol (PDCP) sequence number (SN) information.

5. The method according to claim 2, further comprising:
transmitting, through the source cell or the target cell, first indication information to the terminal, wherein the first indication information is configured to instruct the terminal to transmit the feedback information to the target cell of the network device after the terminal completes a switch from the source cell to the target cell.

6. The method according to claim 5, wherein receiving the feedback information transmitted, after the terminal is switched from the source cell to the target cell, to the target cell of the network device by the terminal comprises:
receiving the feedback information transmitted, after the terminal is switched from the source cell to the target cell, to the target cell of the network device by the terminal according to the first indication information.

7. The method according to claim 2, wherein receiving the feedback information transmitted, after the terminal is switched from the source cell to the target cell, to the target cell of the network device by the terminal comprises:
receiving the feedback information transmitted, in a case where the source cell and the target cell are respectively connected to different distributed units (DUs), to the target cell of the network device by the terminal, wherein the feedback information comprises packet data convergence protocol (PDCP) sequence number (SN) information.

8. The method according to claim 1, further comprising at least one of the following:
stopping or continuing at least one of an uplink data transmission or a downlink data transmission through the source cell in a case where the cell handover message transmitted by the terminal is received through the target cell;
determining to stop at least one of an uplink data transmission or a downlink data transmission through the source cell in a case of the cell handover message transmitted by the terminal being received through the target cell and determining that the terminal completes a switch from the source cell to the target cell; or
transmitting, through the target cell, second indication information to the terminal after the terminal completes a switch from the source cell to the target cell, wherein the second indication information is configured to instruct the terminal to release resources of the source cell.

9-10. (canceled)

11. A method for feeding back information, performed by a terminal, the method comprising:
transmitting a cell handover message to a target cell of a network device, wherein the cell handover message is configured to indicate that the terminal needs to be switched from a source cell to the target cell; and
determining to perform a specific processing flow to feed back feedback information about a physical downlink shared channel (PDSCH) previously transmitted by the source cell of the network device, in a case where the feedback information about the PDSCH previously transmitted by the source cell of the network device has not yet been fed back.

12. The method according to claim 11, wherein determining to perform the specific processing flow comprises one of the following:
determining to cancel transmitting the feedback information to the source cell or the target cell of the network device; or
transmitting the feedback information to the target cell of the network device after the terminal completes a switch from the source cell to the target cell.

13. The method according to claim 12, further comprising:
receiving data that is not successfully transmitted, transmitted/retransmitted by the target cell of the network device in a case where it is determined by default that the terminal has not received the PDSCH after the terminal completes the switch from the source cell to the target cell, in a case of determining by the terminal to cancel transmitting the feedback information to the source cell or the target cell of the network device.

14. The method according to claim 12, wherein transmitting the feedback information to the target cell of the network device comprises:
transmitting the feedback information to the target cell of the network device, wherein the feedback information comprises packet data convergence protocol (PDCP) sequence number (SN) information.

15. The method according to claim 12, wherein before transmitting the feedback information to the target cell of the network device, the method further comprises:
receiving first indication information transmitted by the network device through the source cell or the target cell, wherein the first indication information is configured to instruct the terminal to transmit the feedback information to the target cell of the network device after the terminal completes the switch from the source cell to the target cell.

16. The method according to claim 15, further comprising:
transmitting the feedback information to the target cell of the network device after the terminal completes the switch from the source cell to the target cell, according to the first indication information.

17. The method according to claim 12, wherein transmitting the feedback information to the target cell of the network device comprises:
transmitting the feedback information to the target cell of the network device in a case where the source cell and the target cell are respectively connected to different DUs, wherein the feedback information comprises packet data convergence protocol (PDCP) sequence number (SN) information.

18. The method according to claim 12, further comprising:
maintaining or stopping at least one of an uplink data transmission or a downlink data transmission with the source cell of the network device while accessing to the target cell.

19. The method according to claim 12, further comprising:
receiving second indication information transmitted by the target cell of the network device after the terminal completes the switch from the source cell to the target cell, wherein the second indication information is configured to instruct the terminal to release resources of the source cell.

20. The method according to claim 19, further comprising:
stopping at least one of an uplink data transmission or a downlink data transmission with the source cell of the network device according to the second indication information, in a case where the terminal maintains data transmission with the source cell of the network device while being accessed to the target cell.

21-22. (canceled)

23. A communication device, comprising one or more processors and a memory, wherein the memory stores a computer program, the one or more processors collectively execute the computer program stored in the memory to cause the communication device to:
determine a feedback of a terminal on a physical downlink shared channel (PDSCH) previously transmitted by a source cell of a network device, in a case where a cell handover message transmitted by the terminal is received by a target cell of the network device but feedback information from the terminal about the PDSCH has not yet been received.

24-25. (canceled)

26. A communication device, comprising one or more processors and a memory, wherein the memory stores a computer program, the one or more processors collectively execute the computer program stored in the memory to cause the communication device to perform the method according to any one of claim 11.
